(19) United States
(12) Patent Application Publication
(10) Pub. No.: US 2010/0189992 A1
(43) Pub. Date: Jul. 29, 2010

(54) METHOD FOR PRODUCING PRODUCT HAVING NANOPOROUS SURFACE

(76) Inventor: Takahisa KUSUURA, Kawasaki-shi (JP)

Correspondence Address: FOLEY & LARDNER LLP, 150 EAST GILMAN STREET, P.O. BOX 1497, MADISON, WI, 53701-1497, US

(21) Appl. No.: 12/641,129

(22) Filed: Dec. 17, 2009

(30) Foreign Application Priority Data
Jan. 26, 2009 (JP) 2009-014248

(51) Int. Cl. B32B 3/26; B05D 3/10; B05D 5/00

(52) U.S. Cl. 428/315.5; 427/180; 977/781; 977/888

(57) ABSTRACT

The present invention provides a method for producing a product having a nanoporous surface in which the pore density, pore size or pore size distribution can be easily and readily controlled. The invention provides a method for producing a product having a nanoporous surface including: forming a material in which a plurality of nanoparticles is dispersed in a matrix; and selectively removing the nanoparticles from the material in which a plurality of nanoparticles is dispersed in a matrix.

### CROSS REFERENCE TO RELATED APPLICATION

This application claims the benefit of Japanese Application No. 2009-14248 filed on Jan. 26, 2009 which is incorporated herein by reference.

### BACKGROUND OF THE INVENTION

1. Field of the Invention

This application relates to a method for producing a product having a nanoporous surface, that is, a surface having an indentation of nanometer-level (specifically a pore size of 1000 nm or less) and a method for forming a nanoporous surface on a substrate.

2. Description of the Related Art

A product which has a nanoporous surface has electrical, optical and chemical properties that are different from those of a smooth surface and attracts attention as a functional material in various fields.

As a method for producing a product having a nanoporous surface, a fine pattern processing technique using electron beam exposure and X-ray exposure is considered. In addition, as a method for using a naturally formed structure, there is well known a method of using a nanoporous alumina anode oxidized film formed when aluminum is anode-oxidized in an acidic electrolyte (refer to Japanese Patent Laid-Open No. 11-200090).

However, a fine pattern processing technique requires a complicated processing using an exposure apparatus such as an electron beam exposure apparatus and an X-ray exposure apparatus. Further, in the method of using an alumina anode oxidized film, the porosity, pore size or pore size distribution of the indentation are difficult to control.

For this reason, there has been demanded a method for producing a product having a nanoporous surface in which the pore density, pore size or pore size distribution can be easily controlled in a desired range.

### SUMMARY OF THE INVENTION

As a result of earnest studies on a method for forming a nanoporous surface, the present inventor has found that if a material in which nanoparticles are dispersed in a matrix is prepared and the nanoparticles are selectively removed from the material, a indentation of nanometer level is formed as the removal trace on the surface of the material, and have completed the present embodiments.

### DETAILED DESCRIPTION OF THE PREFERRED EMBODIMENTS

The present embodiments will be described below, but the present invention is not limited to these embodiments.

In the present embodiments, a material, in which a plurality of nanoparticles is dispersed in a matrix, is preliminarily produced and the nanoparticles are selectively removed from the material, thereby transforming the surface of such material to a nanoporous surface.

The method for selectively removing the nanoparticles is not limited and appropriately determined in view of the material constituting the matrix and the material of the nanoparticles. For example, the nanoparticles can be removed by immersing the nanoparticles in a liquid which dissolves the nanoparticles but does not dissolve the matrix and then selectively eluting only the nanoparticles. In addition, the nanoparticles may be removed by sintering at a temperature where the nanoparticles burn but the matrix does not burn.

There is no limitation on the material constituting the nanoparticles and the matrix, and for example, any combination may be used as long as a liquid is available which dissolves the nanoparticles but does not dissolve a matrix. Specifically, there may be used metal particles such as Ag, Cu, Fe, Ni, Cr and Zn particles as nanoparticles, and there may be used a polymer material such as a thermoplastic resin, a hardening resin, an elastomer as the matrix. In addition, metal particles may be used as the nanoparticles, and as the matrix, there may be used a metal such as Au, Pt and Si; an oxide such as quartz and aluminum oxide; a nitride; glass; and other various ceramics. Further, particles consisting of a polymer material may be used as the nanoparticles and a metal or ceramic may be used as the matrix.

The particle size and particle size distribution of the nanoparticles are not limited. Since the pore size of the indentation which is a removal (elution) trace of the nanoparticles is approximately equal to the particle size of the nanoparticles, the pore size and pore size distribution of the nanoporous surface can be controlled by adjusting the particle size and particle size distribution of the nanoparticles. For example, the average particle size of the nanoparticles may be adjusted to a visible light wavelength, specifically 800 nm or less, from the viewpoint of the optical effect. In addition, the average particle size of the nanoparticles may be adjusted to, for example, from 1000 nm to 100 nm, from 100 nm to 10 nm or from 10 nm to 1 nm according to the application of the product having a nanoporous surface.

Further, the term “particle size” as used herein means a biaxial average diameter, that is, an average value of a short diameter and a long diameter when the particle is two-dimensionally observed by a transmission electron microscope (TEM). Here, the terms “short diameter” and “long diameter” mean a short side and a long side, respectively, of a rectangle with a minimum area circumscribed to the particle. And, the average particle size means an average of the particle size of 100 particles randomly selected in the same visual field when the particle is two-dimensionally observed. In addition, the term “pore size” as used herein means a pore diameter measured by the mercury pressure method according to JIS R1655.

Further, the shape of the nanoparticles is similarly not limited, and there may be used nanoparticles having a desired shape as the shape of the indentation of the nanoporous surface, according to the application of the product having a nanoporous surface.

The nanoparticles may be ones produced by any method.

The material that will constitute the matrix may be selected according to the application of the product having a nanoporous surface. Specific examples of the thermoplastic resin include a polyester; a polyamide; a polyolefine; a polycarbonate; a polyimide; a polystyrene or styrene-based copolymer; and a fluorine-containing resin (a polymer obtained by polymerizing a monomer containing a fluorine atom in the molecule) such as a polytetrafluoroethylene (PTFE), a tetrafluoroethylene-perfluoroalkoxy-ethylene copolymer (PFA), a tetrafluoroethylene-hexafluoropropylene copolymer (FEP), a tetrafluoroethylene-ethylene copolymer (ETFE), a polychlorotrifluoroethylene (PCTEF), a chlorotrifluoroethylene-ethylene copolymer (ECTEF), a vinyliden polyfluoride and a vinyl polyfluoride. Specific examples of the hardening resin include an epoxy resin, a phenolic resin, an acrylic resin and an urethane resin. Specific examples of the elastomer include natural rubber, a styrene-butadiene copolymer and a hydrogenated product thereof.

In the production method of the present embodiments, firstly, a material in which nanoparticles are dispersed in a matrix is formed. There is no limitation on the method for forming the material in which a plurality of nanoparticles is dispersed in a matrix, and any method can be employed. For example, there may be employed a metal vapor (co)deposition method such as a vacuum deposition method and an ion plating method.

According to one of the present embodiments, a nanoparticle dispersion solution containing a material comprising a matrix is prepared and the solution is applied onto a substrate, thereby making it possible to form a layer comprised of a material in which nanoparticles are dispersed in a matrix. There is no limitation on the thickness of a layer comprised of a material in which nanoparticles are dispersed in a matrix, and for example, the thickness may be larger or smaller than the average particle size of the nanoparticles.

In the nanoparticle dispersion solution containing a material that will constitute the matrix, the material that will constitute the matrix may be dissolved or dispersed in the nanoparticle dispersion solution. Specific examples of the nanoparticle dispersion solution containing a material that will constitute the matrix include a liquid obtained by dispersing the nanoparticles in a solution in which the material that will constitute the matrix is dissolved or a liquid obtained by dispersing both the particles that will constitute the matrix and the nanoparticles in a dispersion medium. For example, a nanoparticle dispersion solution may be prepared by dispersing nanoparticles in a solution which is prepared by dissolving a material that will constitute the matrix in water or in an organic solvent such as alcohols, a ketone-based solvent, an ester-based solvent, a hydrocarbon-based solvent and a halogen-based hydrocarbon-based solvent, or may be prepared by dispersing nanoparticles in a dispersion solution which is prepared by dispersing particles consisting of a material that will constitute the matrix in a dispersion medium such as water, or may be prepared by dispersing particles consisting of a material that will constitute the matrix in a dispersion solution which is prepared by dispersing nanoparticles in a dispersion medium.

The dispersibility of the nanoparticles in a dispersion solution may be improved by subjecting to surface modification such that the elution of the nanoparticles in the later process is not prevented. An example of the nanoparticles which are subjected to surface modification includes, for example, nanoparticles in which the surface is coated with a protein, a peptide or a vinylpyrrolidone polymer having a low molecular weight.

The surface modification in which a protein or a peptide is immobilized on the surface of nanoparticles can be performed according to the method disclosed in Japanese Patent Laid-Open No. 2007-217331. Specifically, a dispersion solution is prepared by dispersing nanoparticles in water using a surfactant and to the dispersion solution is added a protein or a peptide. Thereafter, an ultrasonic wave is applied to the resulting solution at a pH of 5.0 or higher to replace the surfactant on the surface of the nanoparticles with a protein or a peptide, thereby providing a water dispersion solution of nanoparticles in which a protein or a peptide is immobilized on the surface. For example, a nanoparticle dispersion solution containing a material that will constitute the matrix can be prepared by further dispersing particles consisting of a material that will constitute the matrix in the water dispersion of nanoparticles thus obtained.

In addition, a surface modification, in which nanoparticles are coated with a vinylpyrrolidone polymer having a low molecular weight, can be performed according to the method disclosed in Japanese Patent Laid-Open No. 2008-121043. Specifically, metal nanoparticles are prepared in the presence of a vinylpyrrolidone polymer having a low molecular weight, thereby obtaining metal nanoparticles coated with a vinylpyrrolidone polymer having a low molecular weight. The metal nanoparticles thus obtained, which are coated with a vinylpyrrolidone polymer having a low molecular weight, are dispersed, for example, in an organic solvent such as 1,2-ethanediol. Further, a material that will constitute the matrix is dissolved or particles consisting of a material that will constitute the matrix are dispersed in the metal nanoparticle solution thus obtained, thereby a nanoparticle dispersion solution containing a material that will constitute the matrix can be obtained.

The shape and material of the substrate are not limited, and appropriate ones may be selected depending on the application. For example, regarding the shape of the substrate, a substrate having a three-dimensional form can also be used in addition to a planar substrate. In addition, regarding the material of the substrate, a substrate having flexibility such as a fabric and a nonwoven paper can be used in addition to a substrate having rigidity. Specifically, the material of the substrate includes a glass substrate, a ceramic substrate, a polymer film and a sheet consisting of a fabric.

There is no limitation on the method for applying the nanoparticle dispersion solution onto the substrate, and a conventionally known method, for example, a spraying method, a spin coating and a dip coating method, may be employed.

After the coating, a dispersion medium solvent is removed from a coated layer by drying and the like, and there is formed a layer comprising a material in which a plurality of nanoparticles is dispersed in a matrix. The coated layer may be heated and the material constituting the matrix may be sintered or melted to convert into a strong continuous phase, when needed. When the material constituting the matrix is a polymer material, the coated layer may be heated at or above the glass transition temperature of the polymer material.

According to another embodiment of the present embodiments, there can be formed a material in which nanoparticles are dispersed in a matrix by using so-called mechanical alloying. The term “mechanical alloying” is a solid mixing method in which two or more solids are mixed while applying a large energy to cause repeated lamination, folding and rolling of the solid layers together and then the solids are finely mixed. Theoretically, the solids can be mixed at an atom level. According to mechanical alloying, nanoparticles can be relatively easily and uniformly dispersed in the matrix.

Generally, mechanical alloying is a method used when metals are mixed together. The present inventor has found that mechanical alloying can also be applied to the mixing of polymer materials together or a polymer material and a metal or the like if these materials can be folded and rolled together.

Specifically, there are prepared particles (powders) consisting of a material that will constitute the matrix and particles (powders) consisting of a material that will constitute the nanoparticles, and these particles are mixed while applying a large energy.

According to mechanical alloying, since solid materials are going to be folded and divided in the course of mixing, there can be formed a material in which nanoparticles are dispersed in a matrix even if particles of nanometer-level size are not prepared from the beginning. Therefore, the particle size of particles (powders) consisting of a material that will constitute the nanoparticles prepared in performing mechanical alloying is not required to be nanometer-level, for example, may be 1 to 1000 μm or may be 1 to 100 μm. There is no limitation on the particle size of particles (powders) consisting of a material that will constitute the matrix, and the particle size may be approximately equal to that of particles (powders) consisting of a material that will constitute the nanoparticles, or may be larger than the particles (powders) consisting of a material that will constitute the nanoparticles.

Mechanical alloying can be carried out by using the same method and apparatus as those used in the conventional method for mixing metals together. For example, mechanical alloying can be carried out by mixing using a ball mill such as a rolling ball mill, a vibration mill and a planetary ball mill. In this case, two or more kinds of solid particles are folded and rolled by the collision energy of the balls.

A solid mixture obtained by mechanical alloying is formed into a desired shape and then sintered and melted as needed, thereby a material (a formed product) in which a plurality of nanoparticles is dispersed in a matrix can be obtained.

In addition, there can also be formed a layer comprised of a material in which nanoparticles are dispersed in a matrix on a substrate by using the solid mixture. Specifically, the solid mixture is melted and applied onto the substrate, or a dispersion solution, which is obtained by dispersing the solid mixture in a suitable solvent, can be applied onto the substrate. The above-described method can be employed as a coating method of the dispersion solution. In addition, as described above, the substrate may be a flat plate, one having a three-dimensional form, one having rigidity or one having flexibility.

The content of the nanoparticles in the matrix is not limited and can be appropriately determined depending on the density of a desired indentation. In order to elute the nanoparticles in an immersion solution, at least a part of the nanoparticles is required to be exposed from the matrix. From the viewpoint of the above, depending on the desired density of the indentation, the content of the nanoparticles may be 30% by volume or more, 50% by volume or more, 70% by volume or more, or 90% by volume or more, based on the total volume of the material constituting the nanoparticles and the matrix.

The nanoparticles are selectively removed from the material formed as above in which the nanoparticles are dispersed in a nanoparticle matrix.

As the method for selectively removing the nanoparticles, in the case of employing a method of immersing the nanoparticles in a liquid which dissolves the nanoparticles but does not dissolve the matrix to elute the nanoparticles in the liquid, there is no limitation on the liquid which dissolves the nanoparticles but does not dissolve the matrix, and an appropriate one may be selected depending on the combination of the nanoparticles and the material constituting the matrix. For example, in the case of using metal particles as the nanoparticles and a polymer materials as the matrix, there may be used an acid solution such as hydrochloric acid, nitric acid and sulfuric acid or an alkali solution such as a sodium hydroxide aqueous solution and a potassium hydroxide aqueous solution.

The immersion time is not limited, and the immersion may be carried out for a sufficient period until the nanoparticles are eluted. During the immersion, supplementary processing may be carried out in order to accelerate the elution of the nanoparticles, and for example, an ultrasonic wave is applied to a sample.

After the elution, washing with water is carried out if necessary and then dried, thereby providing a product having a nanoporous surface.

Next, an example of a procedure of the present embodiment will be described.

A polymer material, which is prepared as a material that will constitute the matrix, is added into an organic solvent, followed by stirring and dissolving to prepare a uniform solution. Metal particles having a particle size of nanometer-level are dispersed in the resulting solution to obtain a nanoparticle dispersion solution. Thereafter, the nanoparticle dispersion solution is applied onto a substrate and the coated substrate is dried to remove the organic solvent. After drying, a sample having a layer in which nanoparticles are dispersed in a matrix is obtained on the substrate. The resulting sample is immersed in an acid solution for a predetermined period of time and then taken out from the acid solution, followed by washing and drying to obtain a product having a nanoporous surface.

In addition, another example of a procedure of the present embodiments will be described.

A powder of a polymer material which is a material that will constitute the matrix and a metal powder that will constitute the nanoparticles are prepared, and these are mixed for a predetermined period of time using a ball mill. The resulting solid mixture is dispersed in water to obtain a dispersion solution. Thereafter, the dispersion solution is applied onto a substrate and the coated substrate is dried, followed by heating at or above the glass transition temperature of the polymer material that will constitute the matrix for a predetermined period of time, if needed, to obtain a sample having a layer in which a plurality of nanoparticles is dispersed in the matrix on a substrate. The resulting sample is immersed in an acid solution for a predetermined period of time and then taken out from the acid solution, followed by washing and drying to obtain a product having a nanoporous surface.

It should be noted that these embodiments are mere examples. The present invention is not limited to the embodiments described above, and modifications may be appropriately made within the scope not departing from the gist of the invention.

Since a product having a nanoporous surface produced according to the present embodiments has an extremely large surface area, it can be used, for example, as an adsorbent, a separation film, a catalyst and a catalyst support. In addition, the product can also be used as parts of various devices such as an electrode.

In addition, the present inventor has found that a material having a nanoporous surface has an excellent antibacterial and/or sterilization effect. The reason is presumed that bacteria or viruses or the like are likely to be entrapped in the indentation having a pore size of nanometer-level and the bacteria or viruses once entrapped are difficult to propagate.

Therefore, the product having a nanoporous surface produced according to the present embodiments is formed into a sheet shape and thus it can be used as an antibacterial sheet or a sterilization sheet. Such an antibacterial sheet or a sterilization sheet exhibits a sufficient antibacterial and/or sterilization effect without using chemical products, and if chemical products are used, a more intensive effect, that is, a stronger antibacterial and/or sterilization effect can be expected.

Since the size of viruses is typically 20 to 970 nm and most viruses have a size of 300 nm or less, in the case of producing an antibacterial sheet or a sterilization sheet, nanoparticles having an average particle size of 300 to 1000 nm may be used.

In addition, according to the present embodiments, because a nanoporous surface can be formed on a substrate having an arbitrary structure, the method can be applied for improvement in adhesiveness of the substrate and the like as a novel surface treatment method.

What is claimed is:

1. A method for producing a product having a nanoporous surface, the method comprising:
preparing a substrate;
preparing a nanoparticle dispersion solution comprising a material that will constitute a matrix;
applying the nanoparticle dispersion solution onto the substrate; and
immersing a material in which a plurality of nanoparticles is dispersed in the matrix in a liquid which dissolves the nanoparticles but does not dissolve the matrix to selectively remove the nanoparticles from the material in which a plurality of nanoparticles is dispersed in a matrix.

2. A method for producing a product having a nanoporous surface, the method comprising:
forming a material in which a plurality of nanoparticles is dispersed in a matrix; and
selectively removing the nanoparticles from the material in which a plurality of nanoparticles is dispersed in a matrix.

3. The method for producing a product having a nanoporous surface according to claim 2, wherein the selectively removing of the nanoparticles from the material in which a plurality of nanoparticles is dispersed in a matrix is carried out by immersing a material in which a plurality of nanoparticles is dispersed in a matrix in a liquid which dissolves the nanoparticles but does not dissolve the matrix.

4. The method for producing a product having a nanoporous surface according to claim 3, wherein the liquid which dissolves the nanoparticles but does not dissolve the matrix is an alkali solution or an acid solution.

5. The method for producing a product having a nanoporous surface according to claim 2, wherein the nanoparticles are metal particles.

6. The method for producing a product having a nanoporous surface according to claim 2, wherein the nanoparticles are Ag particles.

7. The method for producing a product having a nanoporous surface according to claim 2, wherein the matrix comprises a polymer material.

8. The method for producing a product having a nanoporous surface according to claim 2, wherein the matrix is a fluororesin.

9. The method for producing a product having a nanoporous surface according to claim 2, wherein the forming of the material in which a plurality of nanoparticles is dispersed in a matrix comprises:
preparing a substrate;
preparing a nanoparticle dispersion solution comprising a material constitutes the matrix; and
applying the nanoparticle dispersion solution onto substrate.

10. The method for producing a product having a nanoporous surface according to claim 2, wherein the forming of the material in which a plurality of nanoparticles is dispersed in a matrix comprises:
preparing a solid mixture by mixing particles consisting of a material that will constitute the matrix with particles consisting of a material that will constitute the nanoparticles.

11. The method for producing a product having a nanoporous surface according to claim 10, wherein the mixing is carried out by using a ball mill.

12. A method for forming a nanoporous surface on a substrate, comprising:
forming a layer in which a plurality of nanoparticles is dispersed in a matrix on a substrate; and
selectively removing the nanoparticles from the layer in which a plurality of nanoparticles is dispersed in a matrix.

13. A product having a nanoporous surface produced by forming a material in which a plurality of nanoparticles is dispersed in a matrix; and
selectively removing the nanoparticles from the material in which a plurality of nanoparticles is dispersed in a matrix.
